(19) United States
(12) Patent Application Publication
(10) Pub. No.: US 2019/0114319 A1
(43) Pub. Date: Apr. 18, 2019

(54) STREAMING LATENT DIRICHLET ALLOCATION

(71) Applicant: Oracle International Corporation, Redwood Shores, CA (US)

(72) Inventors: Jean-Baptiste Tristan, Lexington, MA (US); Michael Wick, Medford, MA (US); Stephen Green, Burlington, MA (US)

(21) Appl. No.: 15/934,262

(22) Filed: Mar. 23, 2018

Related U.S. Application Data
(60) Provisional application No. 62/573,604, filed on Oct. 17, 2017.

(51) Int. Cl. G06F 17/27; G06N 5/04; G06F 17/22; G06F 17/30

(52) U.S. Cl. CPC G06F 17/2715; G06F 17/30705; G06F 17/2276; G06N 5/04

(57) ABSTRACT

Embodiments make novel use of random data structures to facilitate streaming inference for a Latent Dirichlet Allocation (LDA) model. Utilizing random data structures facilitates streaming inference by entirely avoiding the need for pre-computation, which is generally an obstacle to many current “streaming” variants of LDA as described above. Specifically, streaming inference—based on an inference algorithm such as Stochastic Cellular Automata (SCA), Gibbs sampling, and/or Stochastic Expectation Maximization (SEM)—is implemented using a count-min sketch to track sufficient statistics for the inference procedure. Use of a count-min sketch avoids the need to know the vocabulary size V a priori. Also, use of a count-min sketch directly enables feature hashing, which addresses the problem of effectively encoding words into indices without the need of pre-computation. Approximate counters are also used within the count-min sketch to avoid bit overflow issues with the counts in the sketch.

### PRIORITY CLAIM

This application claims the benefit of Provisional U.S. Patent Application No. 62/573,604 (Applicant docket no. 50277-5229), titled “Streaming Latent Dirichlet Allocation”, filed Oct. 17, 2017, the entire contents of which is incorporated by reference as if fully set forth herein.

Furthermore, this application is related to the following applications, the entire contents of each of which is incorporated by reference as if fully set forth herein:
U.S. patent application Ser. No. 14/820,169 (Applicant docket no. 50277-4738), titled “Method And System For Latent Dirichlet Allocation Computation Using Approximate Counters”, filed Aug. 6, 2015; and
U.S. patent application Ser. No. 14/932,825 (Applicant docket no. 50277-4821), titled “Learning Topics By Simulation Of A Stochastic Cellular Automaton”, filed Nov. 4, 2015.

### FIELD OF THE INVENTION

Embodiments relate to fitting a topic model to a sample set of documents and, more specifically, to using probabilistic data structures to store sufficient statistics for a streaming inference procedure to fit a topic model to a very large, or streaming, sample set of documents.

### BACKGROUND

Machine learning involves implementing an inference procedure, such as Gibbs sampling or Stochastic Cellular Automata (SCA), on a statistical model. One example of a statistical model is a Latent Dirichlet Allocation (LDA) model, which is designed with the underlying assumption that words belong to sets of topics, where a topic is a set of words. An inference procedure fits a statistical model to a particular sample set of documents by identifying values for parameters of the statistical model, i.e., θ and φ, that best explain the data in the particular sample set of documents.

The resulting fitted statistical model (also referred to herein as a “topic model”) may be used to correlate words within documents that were not included in the sample set of documents. To illustrate, a topic model that has been fitted to a sample set of documents from a scientific journal can then be used to automatically discover correlated words within a set of documents from another source, such as Wikipedia. Such automatic correlation of words can be used as building blocks for complex, statistics-based computations, such as natural language processing, image recognition, retrieving information from unorganized text, etc. For example, topic modeling can be a key part of text analytics methods requiring automatic identification of correlated words, such as Name Entity Recognition, Part-of-Speech Tagging, or keyword search.

The selection of a sample set of documents on which to train a topic model affects the utility of the topic model. A large sample set of documents for a topic model expands the utility or increases the precision of the topic model when compared to a topic model that was trained over a smaller sample set of documents that are of similar quality. However, fitting a topic model to a large sample set of documents can be very expensive, and can exceed potential time constraints on training the model.

In an effort to increase sample set sizes, various methods of training topic models over a data stream, such as a news or social media feed, have been attempted. A model that is trained over a streaming sample set of data is referred to herein as a “streaming” topic model. Utilizing a data stream as the sample set for a topic model allows the streaming topic model to increase in precision and utility for as long as the topic model is trained over the data stream.

However, there are two important considerations when designing a streaming topic model: model considerations and inference considerations. Model considerations are important for designing technically-sound strategies for fitting a streaming topic model to a stream of new data from the streaming sample set of data. Inference considerations are also important because the streaming model must cope with the growing volume of data modeled therein without having to constantly reallocate data structures.

While there has been some progress towards designing a streaming version of LDA, most of the work has considered the problem from the perspective of model considerations while ignoring inference considerations. In particular, many approaches overlook the following questions, which are typically answered via a pre-processing step of the inference algorithm:

1. What is the size of the vocabulary V?

2. How to encode words as integers?

Nevertheless, in a streaming implementation of LDA, it is not possible to pre-process the streaming sample set of data to determine the size of the vocabulary V of the data set or how the different words in the data set should be encoded as integers. Notwithstanding this limitation, implementations of streaming LDA generally ignore the issues mentioned above and rely, instead, on pre-processing. This reliance on pre-processing makes previously-devised algorithms ineffective for real streaming purposes.

Further, the issue of not knowing the size of vocabulary V has been addressed in the past by designing a new non-parametric topic model that does not make assumptions about the vocabulary size. The downside of such a method is that the learning algorithm, when compared to learning algorithms for LDA, is much more complicated, is relatively slow, and does not scale well. This learning algorithm also fails to address the encoding of words from the sample set of data, and fails to account for potentially very large word frequency counts.

Feature hashing avoids the need to encode the words, but bloats the size of data structures that store the sufficient statistics (called “sufficient” because these statistics capture what is needed, from the sample set of data, for a topic model). The sufficient statistics for an inference procedure are the statistics that have been derived from the sample set of documents by the inference procedure, including the words per topic counts, the topics per document counts, and the counts for the number of times each topic has been used in the sample set.

It is possible to make educated guesses about the size of the vocabulary of a streaming sample set of data or how words should be encoded as integers from the streaming set. However, as the growing volume of data renders such guesses inadequate, it would inevitably be necessary to re-initialize the data structures storing sufficient statistics for the inference procedure, or even to re-run inference from scratch.

It would be beneficial to efficiently fit topic models to a streaming sample set of documents without any need to pre-process the streaming sample set of documents, and without requiring re-initialization of data structures that store sufficient statistics for the inference procedure.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 depicts a non-streaming version of a Stochastic Cellular Automata inference procedure.

FIG. 2 depicts an example of a count-min sketch-based implementation of Stochastic Cellular Automata.

FIG. 3 depicts an example of incrementing a count-min sketch.

FIG. 4 depicts an example of reading a count-min sketch.

FIG. 5 depicts an example network arrangement on which a streaming inference procedure may be implemented.

FIG. 6 is a block diagram of a computer system on which embodiments may be implemented.

FIG. 7 is a block diagram of a basic software system that may be employed for controlling the operation of a computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Embodiments make novel use of random data structures to facilitate streaming inference for a Latent Dirichlet Allocation (LDA) model. According to one or more embodiments, utilizing random data structures facilitates streaming inference by entirely avoiding the need for pre-computation, which is generally an obstacle to many current “streaming” variants of LDA as described above. Despite using various randomized data structures to represent the sufficient statistics, embodiments converge to similar perplexities as non-streaming LDA while incurring little computational overhead and producing good quality topics.

Specifically, according to one or more embodiments, streaming inference—based on an inference algorithm such as Stochastic Cellular Automata (SCA), Gibbs sampling, and Stochastic Expectation Maximization (SEM)—is implemented using a count-min sketch to track sufficient statistics for the inference procedure. Use of a count-min sketch avoids the need to know the vocabulary size V a priori. Also, use of a count-min sketch directly enables feature hashing, which addresses the problem of effectively encoding words into indices without the need of pre-computation. According to one or more embodiments, approximate counters are also used within the count-min sketch to avoid bit overflow issues with the counts in the sketch.

Such use of probabilistic data structures according to embodiments avoids the need to initialize non-probabilistic data structures based on a guess of the size of the vocabulary in the sample set of documents, and then having to subsequently re-allocate the data structures when the guess of the vocabulary size is determined to be incorrect. Because the data structures need only be initialized one time, embodiments conserve processing power of an implementing computing device.

Also, feature hashing based on the probabilistic data structures, according to embodiments, is accomplished without bloating the size of the data structures to accommodate hash functions being used for the features hashing. Because the probabilistic data structures have less unused allocated space than the bloated data structures that result from using feature hashing with non-probabilistic data structures, such embodiments conserve the storage resources of implementing computing devices.

According to embodiments, the combined use of feature hashing and a count-min sketch may be configured to store the sufficient statistics in a probabilistic data structure that occupies less memory than a non-probabilistic data structure would necessarily require. In this way, embodiments use less memory of an implementing computing device. Also, in a distributed implementation, such smaller data structures would require less bandwidth to communicate sufficient statistics between nodes of the cluster of machines implementing the distributed inference.

Furthermore, use of probabilistic data structures, according to embodiments, does not require the use of any inefficient and relatively complicated non-parametric topic model. Embodiments require much less processing power, from an implementing computing device, to perform the same task as a non-parametric topic model.

### Latent Dirichlet Allocation

Latent Dirichlet Allocation (LDA) is a probabilistic topic model used for unsupervised learning. An LDA model is defined as follows:

| | |
|---|---|
| M | (Number of documents) |
| ∀m ∈ { 1 . . . M }, Nₘ | (Length of document m) |
| V | (Size of the vocabulary) |
| K | (Number of topics) |
| α ∈ [symbol] ^{K} | (Hyperparameter controlling |
| | documents) |
| β ∈ [symbol] ^{V} | (Hyperparameter controlling topics) |
| ∀m ∈ { 1 . . . M }, θₘ~Dir(α) | (Distribution of topics in |
| | document m) |
| ∀k ∈ {1 . . . K}, φₖ~Dir(β) | (Distribution of words in topic k) |
| ∀m ∈ { 1 . . . M }, | (Topic assignment) |
| ∀n ∈ {1 . . . Nₘ}, zₘₙ~Cat(θₘ) | |
| ∀m ∈ { 1 . . . M }, | (Corpus content) |
| ∀n ∈ {1 . . . Nₘ}, wₘₙ~Cat(φ_{z}_{ₘₙ}) | |

The model needs to be fitted to some sample set of data, an operation referred to as learning or training. There are a variety of different inference algorithms for fitting such a model. One algorithm that has become popular to train LDA on very large datasets is SCA. SCA is highly scalable, making it suitable for handling large volumes of data in a streaming environment, e.g., over a billion tokens per second. Also, because SCA resets the sufficient statistics after each iteration, SCA only requires increments to the counts, which enables the use of probabilistic counters. Embodiments are described in the context of SCA. However, embodiments are applicable to any inference procedure that is based on updating counts without requiring that the counts be decremented.

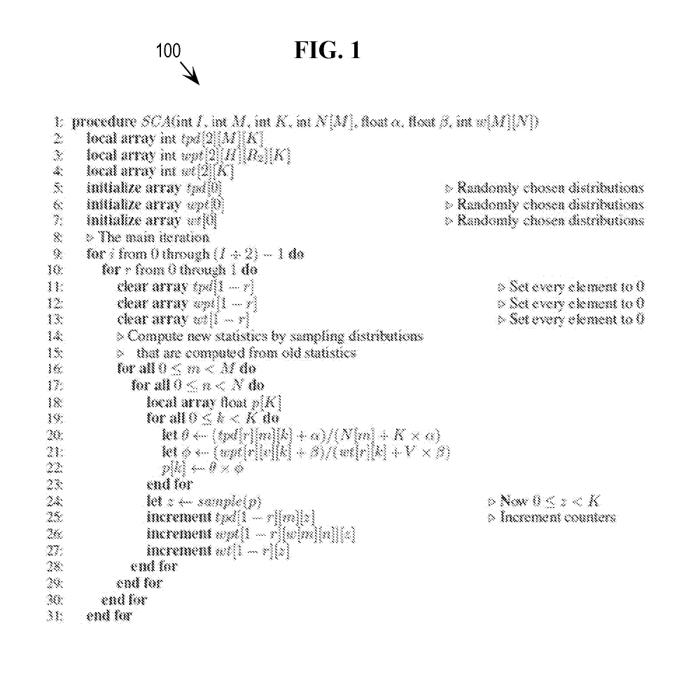

A “non-streaming” version of SCA is presented in pseudocode in FIG. 1, and has the following parameters: I is the number of iterations to perform; M is the number of documents; V is the size of the vocabulary; K is the number of topics; N[M] is an integer array of size M that describes the shape of the data w; α is a parameter that controls how concentrated the distributions of topics per documents should be; β is a parameter that controls how concentrated the distributions of words per topics should be; w[M][N] is a ragged array containing the document data (where subarray w[m] has length N[m]); θ[M][K] is an M×K matrix where θ[m][k] is the probability of topic k in document m; and φ[V][K] is a V×K matrix where φ[v][k] is the probability of word v in topic k. Each element w[m][n] is a nonnegative integer less than V, indicating which word in the vocabulary is at position n in document m. The matrices θ and φ are typically initialized, by the caller, to randomly chosen distributions of topics for each document and words for each topic; these same arrays serve to deliver “improved” distributions back to the caller.

The algorithm for a non-streaming version of SCA (as depicted in FIG. 1) uses three local data structures to store various statistics about the model (lines 2-4): tpd[M][K] is an M×K matrix where tpd[m][k] is the number of times topic k is used in a document m; wpt[V][K] is a V×K matrix where wpt[v][k] is the number of times word v is assigned to a topic k; and wt[K] is an array of size K where wt[k] is the total number of times topic k is in use. As shown in FIG. 1, SCA utilizes two copies of each of these data structures because the algorithm alternates between reading one to write in the other, and vice versa.

The non-streaming SCA algorithm iterates over the data to compute statistics for the topics (see the loop starting on line 9 and ending on line 31 of FIG. 1), referred to herein as the “iterative phase”. The output of SCA are the two probability matrices θ and φ, which need to be computed in a post-processing phase that follows the iterative phase. This post-processing phase is similar to the one of a classic collapsed Gibbs sampler. In this post-processing phase, the θ and φ distributions are computed as the means of Dirichlet distributions induced by the statistics determined during the iterative phase.

In the iterative phase of SCA, the values of θ and φ, which are necessary to compute the topic proportions, are computed on the fly (see lines 20 and 21 of FIG. 1). Unlike the Gibbs algorithm (where in each iteration there is a back-and-forth between two phases, where one phase reads θ and φ in order to update the statistics and the other phase reads the statistics in order to update θ and φ), SCA performs the back-and-forth between two copies of the statistics. Therefore, the number of iterations of the main loop is halved (see line 9 of FIG. 1), and each iteration of the main loop has two sub-iterations (see line 10 of FIG. 1): one sub-iteration that reads tpd[0], wpt[0], and wt[0] in order to write tpd[1], wpt[1], and wt[1], then another sub-iteration that reads tpd[1], wpt[1], and wt[1] in order to write tpd[0], wpt[0], and wt[0].

The following references include more information about LDA and SCA, and each of the following is incorporated by reference as if fully set forth herein:
a. David M. Blei, Andrew Y. Ng, and Michael I. Jordan. Latent dirichlet allocation. J. Mach. Learn. Res., 3:993-1022, March 2003.
b. Jianfei Chen, Kaiwei Li, Jun Zhu, and Wenguang Chen. Warplda: A cache efficient o(1) algorithm for latent dirichlet allocation. Proc. VLDB Endow., 9(10):744-755, June 2016.
c. Manzil Zaheer, Michael Wick, Jean-Baptiste Tristan, Alex Smola, and Guy Steele. Exponential stochastic cellular automata for massively parallel inference. In Arthur Gretton and Christian C. Robert, editors, Proceedings of the 19th International Conference on Artificial Intelligence and Statistics, volume 51 of Proceedings of Machine Learning Research, pages 966-975, Cadiz, Spain, 09-11 May 2016. PMLR.

### Streaming LDA

In a streaming implementation of LDA, it is not possible to determine, for a streaming sample set of data during pre-processing, the size of the vocabulary V or how the different words in the data stream should be encoded as integers. As such, embodiments address at least these two key challenges for streaming LDA.

### Unknown Vocabulary Size

In a streaming environment, the vocabulary size V cannot be pre-computed a priori, and the final size remains unknown throughout the course of inference. Consequently, this makes it difficult to know how large to make certain kinds of data structures (such as matrices) that are generally used for the algorithm. For example, the words-per-topic counts (wpt) is typically represented in a K×V matrix whose size depends directly on V. Instead, embodiments employ a count-min sketch, which does not require the vocabulary size to initialize or to function properly.

### Count-Min Sketch

A count-min sketch is a randomized data structure that maintains approximate counts of how many times distinct events have happened in a given stream. A count-min sketch includes k hash functions h₁ . . . hₖ, each of which has a range of r bits, and also includes a k×r matrix, the values of which are initialized to 0. Each hash function is identified by a unique ordinal identifier (i.e., 0, 1, 2 . . . ), which ordinal identifiers are utilized in updating the count-min sketch. For example, a count-min sketch is updated to track the occurrence of an event e from a stream of events by, for each hash function hᵢ, incrementing the value in the count-min sketch matrix at index (i, hᵢ(e)), where i represents an ordinal identifier of the respective hash function.

The count-min sketch is queried to determine how many times an event e has happened by, for each hash function hᵢ, retrieving the value stored in the count-min matrix at the index (i, hᵢ(e)) to produce a plurality of count values for event e. The minimum of the plurality of count values for event e is returned as an estimate of the number of times the event e has occurred. This estimate of the frequency of event e is approximate, but this approximation can be made precise by an appropriate choice of the number and the range of the hash functions.

The following reference describes count-min sketches, and is incorporated by reference as if fully set forth herein: Graham Cormode and S. Muthukrishnan. An improved data stream summary: The count-min sketch and its applications. J. Algorithms, 55(1):58-75, April 2005.

### Count-Min Sketch to Count Words per Topics Assignments

In SCA, unlike many other inference algorithms for LDA, it is only necessary to increment counts in the matrix wpt and it is never necessary to decrement them. Also, all of the counts are re-initialized between iterations. Consequently, embodiments employ a count-min sketch to represent the words per topic counts during inference. Such utilization of a count-min sketch allows SCA to effectively track the words per topic counts without pre-processing the sample set to determine the size of vocabulary V and without requiring re-initialization of the data structure during inference. The deviation of count approximations produced by a count-min sketch from the true counts of words per topic does not impede inference in practice.

Thus, according to one or more embodiments, a matrix of dimensions 2×X×K, where X equals H×R₂, is created to store the words per topic counts for inference over a given streaming sample set of data. K is the number of topics that the inference is configured to discover, H is the number of hash functions for the count-min sketch, R₂ is the range of these hash functions, and the factor of 2 is because SCA maintains two data structures for the sufficient statistics (one for reading, one for writing).

A possible concern for such an approach is that distinct words might end up sharing the same counts; however, the count-min sketch guarantees that the estimate \hat{v} of a true count v will be such that

$$v \leq \hat{v} + T \times \frac{e}{{2}^{{R}_{2}}}$$

with probability 1−e^{-H}. Moreover, it is shown experimentally that H and R₂ can be chosen so that the statistical performance is as good as if embodiments were keeping track of the true counts, e.g., via a matrix as utilized in the non-streaming inference algorithm of FIG. 1.

Note that a key property of the count-min sketch is that it is easy to distribute. Thus, according to one or more embodiments, if a stream of words from a sample set of documents being used to train a streaming LDA model is split into two sub-streams e₁ and e₂, then embodiments use two count-min sketches c₁ and c₂ to count the frequency of events for the streams, respectively. According to such embodiments, a computing system implementing the streaming LDA model estimates the frequency count for the stream e (comprising e₁ and e₂) by adding together c₁ and c₂.

### Word Encodings

For efficient implementation of the learning algorithm, it is critical to encode the words as integers in order to avoid having to work with strings. Using strings to represent words from the sample set of documents for purposes of inference requires more space than using integers to represent the words. Furthermore, representing the words as strings precludes employing arrays—where indexing can be used to efficiently look up a word—for the underlying data structures. Again, it might be attempted to use dynamic data structures and assign codes to words on-the-fly, but this would be prohibitively expensive. Instead, embodiments implement an alternative solution for mapping words to integers that is based on feature hashing.

### Feature Hashing

When working with text documents, it is customary to associate an integer with each possible word to transform an array of strings into an array of integers. When it is not possible to pre-compute such an encoding, one possibility is to use a hash function to assign words to integers, which is a method know as feature hashing. Feature hashing can be implemented very efficiently and alleviates the need to pre-compute an encoding. However, the hash function can introduce collisions (i.e., causing two words to share the same encoding). In many machine learning applications, it has been shown that, despite such collisions, learning can be done effectively and quickly by hashing features. However, unlike fitting a topic model to a sample set of documents, most of these applications are supervised classification in which the predicted output label is important and the interpretation of the individual input features are not typically critical.

In contrast, fitting a topic model to a sample set of documents requires representations of the input words themselves. As such, in the context of training a topic model, word representation collisions are less tolerable, and implementation of feature hashing requires use of a large enough hash to avoid too many collisions. In the context of a non-streaming implementation of SCA, a larger hash would require allocation of larger data structures (for example, a very large wpt matrix since the matrix must accommodate all possible hash values from the larger hash) and many of the hash values that could potentially be generated from the larger hash will be unused. This is inefficient storage allocation, and is wasteful.

It is possible to compute a hash as a table at runtime: for every word, look up the table to see if the word has been assigned a code yet, and if not, choose the next available code. If no codes are available, then reuse an existing one. The advantage of such a method is that it guarantees that all of the codes are used, which would avoid a waste of space for the wpt matrix. However, in the context of a parallel/distributed implementation in which different threads/nodes see different data, the consequence is that table creation would need to be synchronized. This can become quite complicated since two nodes could assign, to the same code, two different words (or different codes to the same word), which would need to be resolved. One could imagine allowing collisions, but that would potentially lead to high-consequence collisions between high-frequency words.

### Sketches Enable Feature-Hashing

Employing a count-min sketch to represent wpt counts for inference enables useful possibilities. First, assuming the use of a count-min sketch with k hash functions each having an R₂ range of bits, one or more embodiments choose the encoding for any given word to be the concatenation of the k number of R₂-bits hash values generated by the k hash functions run over that word. In this way, the count-min sketch is used directly for feature hashing. This is an effective possibility, but uses a large number of bits to represent a word, i.e., k×R₂ bits.

According to further embodiments, a classic hash function from string to R₁-bits, in which R₁ is chosen freely, is used as a feature mapping hash function to map words in the sample set of data to integers of length R₁ bits. Such an approach would not be viable in the context of non-streaming LDA since it would require setting the number of columns in wpt to 2^{R}^{₁} instead of to V. The resulting wpt matrix would be unreasonably large and would likely make poor use of the memory space, since many indices would end up not being used.

However, according to one or more embodiments, since a count-min sketch is being used to represent wpt, it is not necessary to worry about issues of vocabulary size V. Furthermore, the count-min sketch has its own set of hash functions that are used, according to the one or more embodiments, to map R₁-bit integers representing words into R₂-bit representations. Assuming that the true size of the vocabulary is V, then the probability of a collision is

$$1 - {e}^{\frac{- {V}^{2}}{{}_{2}^{}{R}{}_{1}^{} + 1}} .$$

It is also shown experimentally that learning is largely unaffected by feature hashing with the right configuration, according to one or more embodiments. Further, going through R₁ bits, where R₁ is less than k×R₂ does not appear to be problematic in practice. Note that if the alias method is used to sample from a discrete distribution in constant time, then it is necessary to keep a hash table from all of the codes that are actually used to their corresponding alias table. The topics resulting from such a use of features hashing are of similar quality to baseline models.

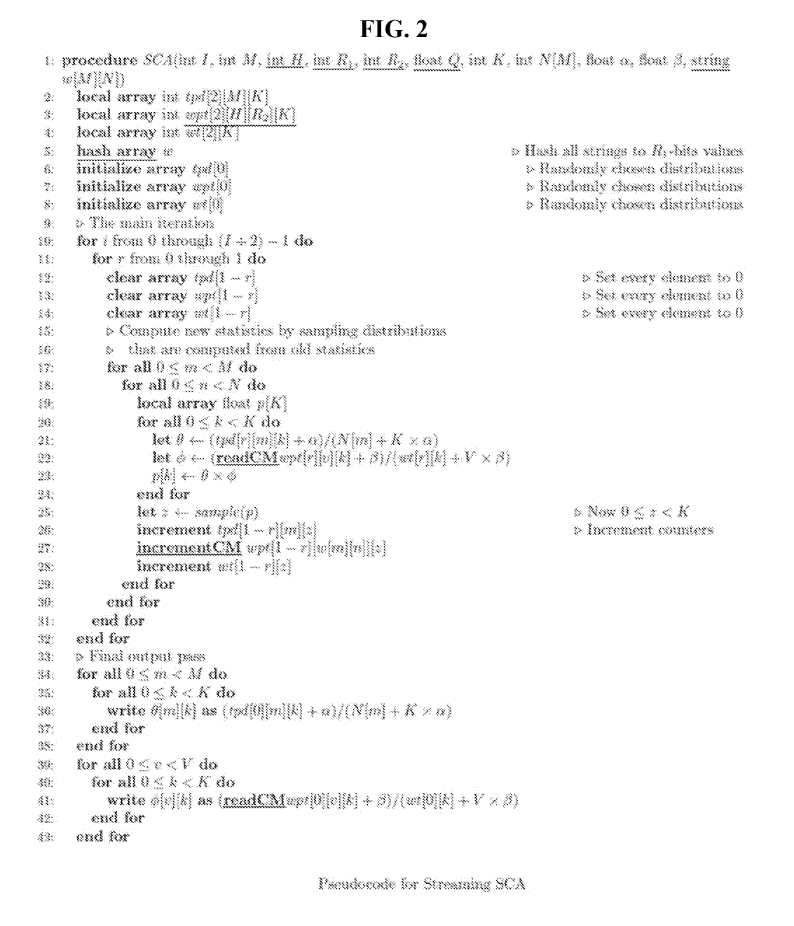

According to one or more embodiments, modifying SCA to support feature hashing and the count-min sketch comprises replacing the read of wpt on line 21 (of the non-streaming SCA shown in FIG. 1) and the write of wpt on line 26 (of FIG. 1) by read and write procedures of the count-min sketch, respectively. Note that, according to one or more embodiments, the input data w on line 1 (of FIG. 1) would not be of type int in a streaming implementation, but rather of type string. Consequently, the data would need to be hashed before the main iteration starts on line 9 (of FIG. 1). See the example implementation of a count-min sketch-based SCA in FIG. 2, which shows these modifications for implementing streaming SCA, according to one or more embodiments.

### Avoiding Count Overflow

An additional consideration, which stems from the potential of very large word counts for large sample sets, is to avoid overflow errors when assignments of words to topics are counted during inference. Overflow of these count values would have disastrous consequences for the learning outcomes. In non-streaming implementations of LDA, the sample data set is pre-processed to determine word frequency in the sample set in order to ensure that the counters have sufficient bits to store the maximum possible count values.

However, in the context of a streaming LDA model, it is not possible to perform such pre-processing. To mitigate this issue for streaming inference, it could be possible to use a large number of bits to represent the various counts, but that would affect the runtime performance significantly, especially in distributed systems where such counts would need to be communicated over a network. As such, one or more embodiments utilize approximate counters to track counts for at least some of the sufficient statistics for streaming inference.

### Approximate Counters

A counter is a data structure that supports three operations: initialization to 0, reading the value of the counter, and adjusting the value of the counter via increment or decrement operations. A counter is typically implemented as a machine integer that is incremented or decremented any time the count value that the counter is configured to track changes.

In contrast with a machine integer, an approximate counter supports initialization to 0, reading a count estimate based on the approximate counter, and incrementing the counter. More specifically, an approximate counter does not keep track of the exact number of times that the counter has been incremented, but rather can be called upon for an approximate estimate of the number of times that the counter has been incremented. The following references include information about approximate counters, and are both incorporated by reference as if fully set forth herein:
Philippe Flajolet. Approximate counting: A detailed analysis. BIT, 25(1):113-134, June 1985; and
Robert Morris. Counting large numbers of events in small registers. Commun. ACM, 21(10):840-842, October 1978.

A typical approximate counter is the Morris counter in base 2. In such a counter, an increment request will effectively increment the counter value X only with a probability of 2^{-X}. A query of a Morris approximate counter with a value of X returns the estimate 2^{X}−1, which is an unbiased estimate of the true number of increments tracked by the approximate counter. Such counters can also be added together, which can be important in the context of distributed applications.

It is possible to use approximate counters within a count-min sketch. As such, one or more embodiments use approximate counters in place of machine-style counters in count-min sketch matrices (and/or other matrices) that represent sufficient statistics for streaming inference. An approximate counter can track a much larger number than a machine counter with the same number of allocated bits. As such, use of approximate counters according to one or more embodiments significantly reduces the chance of overflow error in the counts of sufficient statistics. Furthermore, it can be advantageous to use approximate counters to reduce the memory footprint of a matrix and also to reduce the communication bandwidth required to transmit data for the matrix.

Furthermore, when approximate counters are used in a concurrent context as in a distributed application, it is not necessary to synchronize them. Intuitively, this is because as the value of the counter gets larger, the probability of a collision goes to zero. This is completely wrong for a non-probabilistic data structure (such as an integer counter), but experiments show that such a randomized data structure is resilient to synchronization error, and indeed this behavior has been analyzed theoretically.

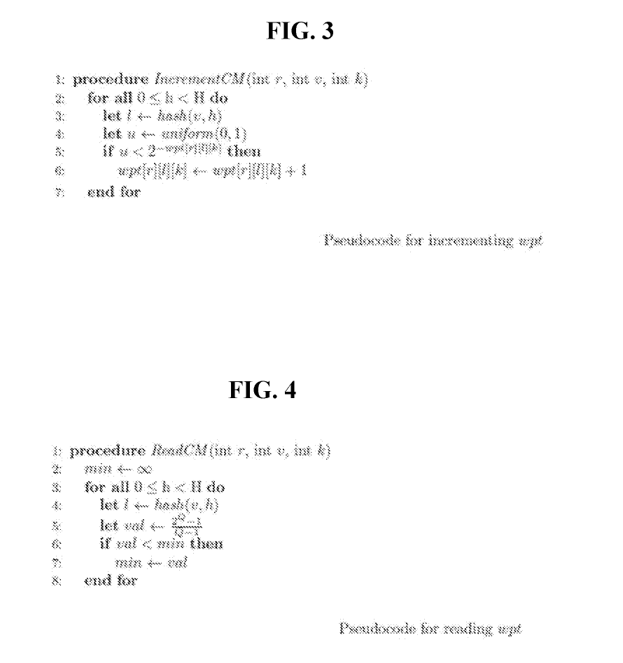

Consequently, wpt, as represented by a count-min sketch utilizing approximate counters, becomes a wait-free data-structure. The incrementing and reading of a count-min sketch using approximate counters can be implemented as shown in FIGS. 3 and 4. Specifically, the example implementation of FIGS. 3 and 4 comprises count-min sketching, approximate counting, and lack of synchronization. It is shown experimentally that combining a count-min sketch, approximate counters, and avoiding synchronization does not negatively impact the inference procedure.

### Inference Procedures

Embodiments are described herein in the context of SCA. However, embodiments are applicable to any inference procedure that is based on updating counts without requiring that the counts to be decremented. According to an embodiment, in a standard (or uncollapsed) Gibbs sampler or in a partially-collapsed Gibbs sampler as described in U.S. patent application Ser. No. 14/820,169, sufficient statistics are stored in a count-min sketch rather than in a matrix as described in detail above. According to an embodiment, feature hashing is implemented for words in a sample set of documents for the Gibbs sampler as described above. Furthermore, according to an embodiments, approximate counters are used in the count-min sketch to record count values for the Gibbs sampler.

As described in detail above, inference using SCA samples the latent variables repeatedly and records the result of the sampling in the sufficient statistics data structure. In contrast, inference using SEM alternates two different phases: In one phase, the sufficient statistics are used to make a new estimate of the parameters of the model. In the other phase, the parameter estimate is used to sample the latent variables and the result is recorded in the sufficient statistics.

### Applying a Trained Topic Model

A topic model may be trained over a streaming sample set of documents until a satisfactory level of convergence is detected, or may continually be updated over a set period of time as new data is obtained from the streaming sample set. A satisfactory level of convergence may be detected based on one or more of: a number of iterations of the inference procedure, the likelihood of the parameters does not increase significantly anymore, the perplexity of the parameters does not decrease anymore, etc.

Once convergence is reached, or the set period of time has expired, the trained topic model assigns each word of the plurality of words in each document of the streaming sample set to a particular topic. According to an embodiment, the plurality of words is less than all of the words in the streaming sample set. According to an embodiment, the plurality of words is all of the words in the streaming sample set.

According to an embodiment, the sets of correlated words are not automatically associated with topic names, or interpretations of the identified correlations, etc. Specifically, the word groupings in a trained topic model are based on correlations that were automatically detected in the given set of documents via the inference algorithm. For example, application of SCA causes identification of a correlation between two words based on the inclusion of the two words together in a single document of the sample set. In a similar vein, application of SCA causes identification of a strong correlation between the two words based on the inclusion of the two words together in each of multiple documents. As a further example, application of SCA causes identification of a strong correlation between the two words based on the inclusion of the two words together in the same sentence in one or more of the documents.

A trained topic model can be used to identify, within one or more documents other than the sample set of documents used to train the topic model, one or more sets of correlated words. For example, a topic model that has been fitted to a sample set of documents from a scientific news feed can then be used to automatically discover correlated words within a set of documents from another source, such as Wikipedia.

Because embodiments may be used to train a topic model over a streaming data set, which is constantly being updated, a topic model that is trained over a portion of a streaming set of data may be used to identify correlated words in documents other than the sample set of documents. Subsequently, the topic model is further trained on additional data from the streaming set of data and then the updated topic model is again used to identify correlated words in documents other than the sample set of documents.

### Architecture for Streaming Inference

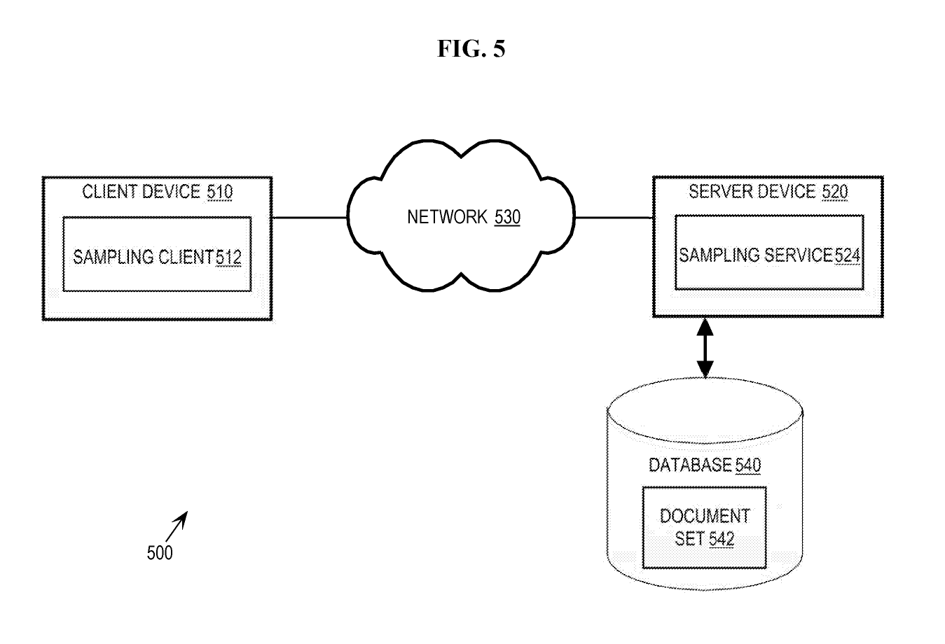

FIG. 5 is a block diagram that depicts an example network arrangement 500 for implementing streaming inference using a count-min sketch, according to one or more embodiments. Embodiments described above are implemented by one or more computing devices, such as those depicted in network arrangement 500. Specifically, network arrangement 500 includes a client device 510 and a server device 520 communicatively coupled via a network 530. Example network arrangement 500 may include other devices, including client devices, server devices, cluster nodes, and display devices, according to one or more embodiments.

Client device 510 may be implemented by any type of computing device that is communicatively connected to network 530. Example implementations of client device 510 include, without limitation, workstations, personal computers, laptop computers, personal digital assistants (PDAs), tablet computers, cellular telephony devices such as smart phones, and any other type of computing device.

In network arrangement 500, client device 510 is configured with a sampling client 512. Sampling client 512 may be implemented in any number of ways, including as a stand-alone application running on client device 510, as a plugin to a browser running at client device 510, etc. According to one or more embodiments, sampling client 512 may be used, by a human or process user, to provide or mine a very large or streaming sample set of documents as described above. For example, a user provides information about document set 542 (depicted within database 540) to sampling client 512. In this example, document set 542 comprises documents retrieved from a data stream, such as a news feed. Sampling client 512 provides the information to a sampling service 524 (of server device 520) that is configured to fit a topic model to the sample set of documents according to one or more embodiments described above.

Document set 542 represents a stream of sample documents (or a very large set of documents) containing unlabeled data, where each document includes words. According to an embodiment, document set 542 is continuously updated with additional documents, e.g., by sampling client 512.

Network 530 may be implemented with any type of medium and/or mechanism that facilitates the exchange of information between client device 510 and server device 520. Furthermore, network 530 may facilitate use of any type of communications protocol, and may be secured or unsecured, depending upon the requirements of a particular embodiment.

Server device 520 may be implemented by any type of computing device that is capable of communicating with client device 510 over network 530. In network arrangement 500, server device 520 is configured with a sampling service 524, which is used to perform the inference procedure according to one or more embodiments described above.

Server device 520 is communicatively coupled to database 540. Database 540 maintains information for a document set 542. Database 540 may reside in any type of storage, including volatile and non-volatile storage (e.g., random access memory (RAM), a removable or disk drive, main memory, etc.). The storage on which database 540 resides may be external or internal to server device 520.

In an embodiment, each of the processes described in connection with sampling client 512, and/or sampling service 524 are performed automatically and may be implemented using one or more computer programs, other software or hardware elements, and/or digital logic in any of a general-purpose computer or a special-purpose computer, while performing data retrieval, transformation, and storage operations that involve interacting with and transforming the physical state of memory of the computer.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

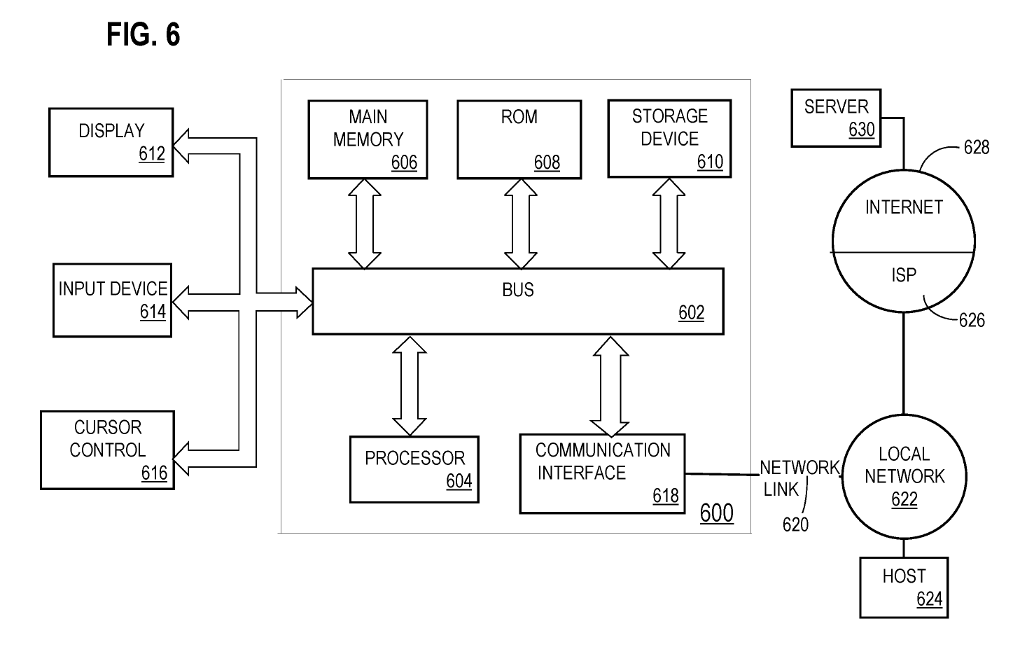

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

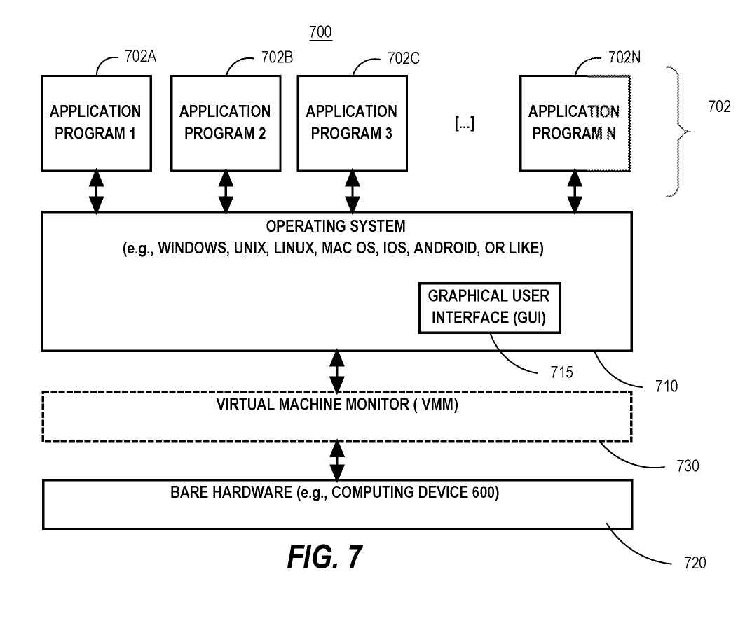

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for identifying sets of correlated words comprising:
receiving information for a sample set of documents;
wherein the sample set of documents comprises a plurality of words;
fitting a statistical model to the plurality of words in the sample set of documents by running an inference procedure on the statistical model to produce a first fitted statistical model, further comprising:
representing particular count values, for the inference procedure, using a count-min sketch;
identifying, within one or more documents other than the sample set of documents and based on the first fitted statistical model, one or more sets of correlated words;
wherein the method is performed by one or more computing devices.

2. The method of claim 1, wherein the inference procedure is stochastic cellular automata.

3. The method of claim 1, wherein the inference procedure is Gibbs sampling.

4. The method of claim 1, further comprising, after fitting the statistical model to the plurality of words in the sample set of documents, wherein the sample set of documents is a first sample set of documents:
receiving information for a second sample set of documents;
wherein the second sample set of documents comprises a second plurality of words;
fitting the first fitted statistical model to the second plurality of words in the second sample set of documents by running the inference procedure on the first fitted statistical model to produce a second fitted statistical model;
wherein the second fitted statistical model is based on sufficient statistics derived from both the first sample set of documents and the second sample set of documents; and
identifying, within second one or more documents other than the first and second sample set of documents, and based on the second fitted statistical model, second one or more sets of correlated words.

5. The method of claim 1, wherein the particular count values are words per topic count values.

6. The method of claim 5 wherein:
the count-min sketch comprises: a count-min sketch matrix and a plurality of hash functions;
each hash function, of the plurality of hash functions, is identified by an ordinal identifier;
fitting the statistical model to the plurality of words in the sample set of documents further comprises incrementing a count value for a particular word, of the plurality of words, within the count-min sketch by, for each of the plurality of hash functions:
running the respective hash function over the particular word to produce a particular hash value; and
incrementing a count value within the count-min sketch matrix at a location identified by both (a) the respective ordinal identifier of the respective hash function, and (b) the particular hash value.

7. The method of claim 6 further comprising, during an output pass of the inference procedure, reading a count value for the particular word from the count-min sketch by:
retrieving a plurality of count sub-values, from the count-min sketch for the particular word, by, for each of the plurality of hash functions:
calculating the respective hash function over the particular word to produce a given hash value, and
retrieving a count sub-value, of the plurality of count sub-values, from the count-min sketch matrix at a location identified by both (a) the respective ordinal identifier of the respective hash function, and (b) the given hash value;
identifying the count value for the particular word to be a minimum count sub-value of the plurality of count sub-values.

8. The method of claim 5, wherein:
the count-min sketch comprises a plurality of hash functions;
the method further comprises assigning, to each word of the plurality of words, an identifier by, for each word of the plurality of words:
calculating a plurality of hash values for the respective word by, for each hash function of the plurality of hash functions:
running the respective hash function over the respective word to produce a respective hash value of the plurality of hash values, and
assigning, to the respective word, a respective identifier comprising all of the plurality of hash values for the respective word.

9. The method of claim 5, further comprising assigning, to each word of the plurality of words, an identifier that comprises a hash value generated from hashing the respective word with a feature mapping hash function.

10. The method of claim 1, wherein:
the count-min sketch includes a plurality of count values; and
each of the plurality of count values is represented by a respective approximate counter.

11. The method of claim 1, wherein the statistical model is a Latent Dirichlet Allocation (LDA) model.

12. One or more non-transitory computer-readable media storing instructions which, when executed by one or more processors, cause identifying sets of correlated words by:
receiving information for a sample set of documents;
wherein the sample set of documents comprises a plurality of words;
fitting a statistical model to the plurality of words in the sample set of documents by running an inference procedure on the statistical model to produce a first fitted statistical model, further comprising:
representing particular count values, for the inference procedure, using a count-min sketch;
identifying, within one or more documents other than the sample set of documents and based on the first fitted statistical model, one or more sets of correlated words.

13. The one or more non-transitory computer-readable media of claim 12, wherein the inference procedure is stochastic cellular automata.

14. The one or more non-transitory computer-readable media of claim 12, wherein the inference procedure is Gibbs sampling.

15. The one or more non-transitory computer-readable media of claim 12, wherein the instructions further comprise instructions which, when executed by one or more processors, cause, after fitting the statistical model to the plurality of words in the sample set of documents, wherein the sample set of documents is a first sample set of documents:
receiving information for a second sample set of documents;
wherein the second sample set of documents comprises a second plurality of words; and
fitting the first fitted statistical model to the second plurality of words in the second sample set of documents by running the inference procedure on the first fitted statistical model to produce a second fitted statistical model;
wherein the second fitted statistical model is based on sufficient statistics derived from both the first sample set of documents and the second sample set of documents.

16. The one or more non-transitory computer-readable media of claim 12, wherein the particular count values are words per topic count values.

17. The one or more non-transitory computer-readable media of claim 16 wherein:
the count-min sketch comprises: a count-min sketch matrix and a plurality of hash functions;
each hash function, of the plurality of hash functions, is identified by an ordinal identifier;
fitting the statistical model to the plurality of words in the sample set of documents further comprises incrementing a count value for a particular word, of the plurality of words, within the count-min sketch by, for each of the plurality of hash functions:
running the respective hash function over the particular word to produce a particular hash value; and
incrementing a count value within the count-min sketch matrix at a location identified by both (a) the respective ordinal identifier of the respective hash function, and (b) the particular hash value.

18. The one or more non-transitory computer-readable media of claim 17 wherein the instructions further comprise instructions which, when executed by one or more processors, cause, during an output pass of the inference procedure, reading a count value for the particular word from the count-min sketch by:
retrieving a plurality of count sub-values, from the count-min sketch for the particular word, by, for each of the plurality of hash functions:
calculating the respective hash function over the particular word to produce a given hash value, and
retrieving a count sub-value, of the plurality of count sub-values, from the count-min sketch matrix at a location identified by both (a) the respective ordinal identifier of the respective hash function, and (b) the given hash value;
identifying the count value for the particular word to be a minimum count sub-value of the plurality of count sub-values.

19. The one or more non-transitory computer-readable media of claim 16, wherein:
the count-min sketch comprises a plurality of hash functions;
the instructions further comprise instructions which, when executed by one or more processors, cause assigning, to each word of the plurality of words, an identifier by, for each word of the plurality of words:
calculating a plurality of hash values for the respective word by, for each hash function of the plurality of hash functions:
running the respective hash function over the respective word to produce a respective hash value of the plurality of hash values, and
assigning, to the respective word, a respective identifier comprising all of the plurality of hash values.

20. The one or more non-transitory computer-readable media of claim 16, wherein the instructions further comprise instructions which, when executed by one or more processors, cause assigning, to each word of the plurality of words, an identifier that comprises a hash value generated from hashing the respective word with a feature mapping hash function.

21. The one or more non-transitory computer-readable media of claim 12, wherein:
the count-min sketch includes a plurality of count values; and
each of the plurality of count values is represented by a respective approximate counter.

22. The one or more non-transitory computer-readable media of claim 12, wherein the statistical model is a Latent Dirichlet Allocation (LDA) model.
